(19) United States
(12) Patent Application Publication
(10) Pub. No.: US 2023/0073477 A1
(43) Pub. Date: Mar. 9, 2023

(54) METHOD, DEVICE, MOBILE DEVICE, AND COMPUTER-READABLE MEDIUM FOR FINGERPRINT AUTHENTICATION

(71) Applicant: Egis Technology Inc., Hsinchu City (TW)

(72) Inventors: JIAN-HUA WANG, Hsinchu City (TW); YUAN-LIN CHIANG, Hsinchu City (TW)

(21) Appl. No.: 17/893,424

(22) Filed: Aug. 23, 2022

Related U.S. Application Data
(60) Provisional application No. 63/240,375, filed on Sep. 3, 2021.

(51) Int. Cl. G06V 40/12; G06V 40/50

(52) U.S. Cl. CPC G06V 40/1365; G06V 40/1335; G06V 40/50

(57) ABSTRACT

A method for fingerprint authentication may include obtaining a target fingerprint region including at least one first fingerprint feature set, judging, according to the at least one first fingerprint feature set and fingerprint feature sets included in a plurality of reference fingerprint regions of a fingerprint database, whether a primary reference fingerprint region associated with the target fingerprint region is included in the fingerprint database, where the plurality of fingerprint regions are formed during fingerprint acquisition of a finger performing arc-shaped sliding on a fingerprint identifier and stored in the fingerprint database, and each of the reference fingerprint regions has a corresponding fingerprint feature, and determining, based on a judgment result, whether the target fingerprint region passes the authentication. The reference fingerprint regions can be acquired quickly in a swiping mode, and an associated reference fingerprint region can be used for fingerprint authentication, thereby significantly speeding up the authentication process.

### CROSS REFERENCE TO RELATED APPLICATIONS AND CLAIM OF PRIORITY

This application claims the benefit under 35 USC § 119 of U.S. Patent Application No. 63/240,375 filed on Sep. 3, 2021 in the US Intellectual Property Office, the entire disclosure of which is incorporated herein by reference for all purposes.

### BACKGROUND

### 1. Technical Field

The present disclosure generally relates to the field of fingerprint identification. More specifically, the present disclosure relates to a method for fingerprint authentication, a device for fingerprint authentication, a mobile device for fingerprint authentication, and a non-transitory computer-readable medium.

### 2. Background of the Invention

With the widespread use of various electronic devices (including smart terminals) in daily life, safe access by the user has become an important factor to be concerned. To ensure security during operation of the devices, various solutions for user authentication have been proposed, some of which make use of biometrics of the user. The fingerprint, as one of the biometrics, has become an effective means for security authentication due to its uniqueness. With accurate fingerprint identification, safe access to the device can be effectively protected, thereby preventing embezzlement of an illegal or unauthorized user.

At present, when a fingerprint identifier with a relatively small sensing area is used for fingerprint enrollment, a sufficient number of fingerprints can be obtained only after many times of pressing, which is time-consuming and thereby reduces the efficiency in fingerprint enrollment.

### SUMMARY

At least in view of the above deficiencies mentioned in the background art, the present disclosure provides a solution for fingerprint authentication.

In a first aspect, the present disclosure provides a method for fingerprint authentication, comprising: obtaining a target fingerprint region to be authenticated, where the target fingerprint region includes at least one first fingerprint feature set; judging, according to the at least one first fingerprint feature set and fingerprint feature sets included in a plurality of reference fingerprint regions of a fingerprint database, whether a primary reference fingerprint region associated with the target fingerprint region is included in the fingerprint database, where the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature; and determining, based on a judgment result, whether the target fingerprint region passes the authentication.

In an embodiment, the target fingerprint region further includes a second fingerprint feature set, and the determining, based on the judgment result, whether the target fingerprint region passes the authentication comprises: selecting, in response to the judgment result that the fingerprint database includes a primary reference fingerprint region associated with the target fingerprint region, at least one corresponding reference fingerprint region from the fingerprint database as a secondary reference fingerprint region according to the primary reference fingerprint region; and determining, based on a comparison of the secondary reference fingerprint region with the second fingerprint feature set, whether the target fingerprint region passes the authentication.

In an embodiment, the fingerprint database further includes relative positional relations between different ones of the plurality of reference fingerprint regions, and the selecting at least one corresponding reference fingerprint region from the fingerprint database as the secondary reference fingerprint region according to the primary reference fingerprint region comprises: selecting, from the fingerprint database, at least one reference fingerprint region having a relative positional relation with the primary reference fingerprint region that meets a first preset condition, as the secondary reference fingerprint region.

In an embodiment, the relative positional relations between different reference fingerprint regions include distances and/or rotation angles between different reference fingerprint regions.

In an embodiment, the determining whether the target fingerprint region passes the authentication comprises: judging whether a comparison result obtained by comparing the secondary reference fingerprint region with the second fingerprint feature set meets a second preset condition; and determining, in response to the comparison result meeting the second preset condition, that the target fingerprint region passes the authentication.

In an embodiment, the comparison result is a similarity score, and the determining that the target fingerprint region passes the authentication comprises: determining, in response to the similarity score corresponding to the comparison result greater than or equal to a score threshold or within a score threshold range, that the target fingerprint region passes the authentication.

In an embodiment, the determining whether the target fingerprint region passes the authentication comprises: judging, in response to the judgment result that the fingerprint database includes a primary reference fingerprint region associated with the target fingerprint region, whether a reference fingerprint region associated with the target fingerprint region is included in a non-relevant fingerprint region of the fingerprint database according to the at least one first fingerprint feature set and the fingerprint feature sets included in the plurality of reference fingerprint regions of the fingerprint database, where the non-relevant fingerprint region is a reference fingerprint region in the fingerprint database that has a relative positional relation with the primary reference fingerprint region meeting a third preset condition; and determining, according to a judgment result, whether the target fingerprint region passes the authentication.

In an embodiment, the determining, according to the judgment result, whether the target fingerprint region passes the authentication comprises: determining, in response to the judgment result that the non-relevant fingerprint region includes a reference fingerprint region associated with the target fingerprint region, that the target fingerprint region fails to pass the authentication.

In an embodiment, each of the reference fingerprint regions in the fingerprint database corresponds to an acquired reference fingerprint image, or each of the reference fingerprint regions includes one or more acquired fingerprint features.

In an embodiment, a plurality of reference fingerprint images or fingerprint features in the fingerprint database are acquired by: acquiring a plurality of reference fingerprint images or fingerprint features while the finger performs the arc-shaped sliding from a first position to a second position on the fingerprint identifier, where the first position and the second position are respectively located on two sides of a preset midline of the fingerprint identifier, and an angle between the first position and the second position is greater than or equal to a preset angle.

In a second aspect, the present disclosure provides a device for fingerprint authentication, comprising: a processor; and a memory storing thereon program instructions executable by the processor, where the program instructions, when executed by the processor, cause the device to perform the operations of: obtaining a target fingerprint region to be authenticated, where the target fingerprint region includes at least one first fingerprint feature set; judging, according to the at least one first fingerprint feature set and fingerprint feature sets included in a plurality of reference fingerprint regions of a fingerprint database, whether a primary reference fingerprint region associated with the target fingerprint region is included in the fingerprint database, where the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature; and determining, based on a judgment result, whether the target fingerprint region passes the authentication.

In an embodiment, the target fingerprint region further includes a second fingerprint feature set, and the program instructions, when executed by the processor, cause the device to perform the operations of: selecting, in response to the judgment result that the fingerprint database includes a primary reference fingerprint region associated with the target fingerprint region, at least one corresponding reference fingerprint region from the fingerprint database as a secondary reference fingerprint region according to the primary reference fingerprint region; and determining, based on a comparison of the secondary reference fingerprint region with the second fingerprint feature set, whether the target fingerprint region passes the authentication.

In an embodiment, the fingerprint database further includes relative positional relations between different ones of the plurality of reference fingerprint regions, and the program instructions, when executed by the processor, cause the device to perform the operation of: selecting, from the fingerprint database, at least one reference fingerprint region having a relative positional relation with the primary reference fingerprint region that meets a first preset condition, as the secondary reference fingerprint region.

In an embodiment, the relative positional relations between different reference fingerprint regions include distances and/or rotation angles between different reference fingerprint regions.

In an embodiment, the program instructions, when executed by the processor, cause the device to perform the operations of: judging whether a comparison result obtained by comparing the secondary reference fingerprint region with the second fingerprint feature set meets a second preset condition; and determining, in response to the comparison result meeting the second preset condition, that the target fingerprint region passes the authentication.

In an embodiment, the comparison result is a similarity score, and the program instructions, when executed by the processor, cause the device to perform the operation of: determining, in response to the similarity score corresponding to the comparison result greater than or equal to a score threshold or within a score threshold range, that the target fingerprint region passes the authentication.

In an embodiment, the program instructions, when executed by the processor, cause the device to perform the operations of: judging, in response to the judgment result that the fingerprint database includes a primary reference fingerprint region associated with the target fingerprint region, whether a reference fingerprint region associated with the target fingerprint region is included in a non-relevant fingerprint region of the fingerprint database according to the at least one first fingerprint feature set and the fingerprint feature sets included in the plurality of reference fingerprint regions of the fingerprint database, where the non-relevant fingerprint region is a reference fingerprint region in the fingerprint database that has a relative positional relation with the primary reference fingerprint region meeting a third preset condition; and determining, according to a judgment result, whether the target fingerprint region passes the authentication.

In an embodiment, the program instructions, when executed by the processor, cause the device to perform the operation of: determining, in response to the judgment result that the non-relevant fingerprint region includes a reference fingerprint region associated with the target fingerprint region, that the target fingerprint region fails to pass the authentication.

In an embodiment, each of the reference fingerprint regions in the fingerprint database corresponds to an acquired reference fingerprint image, or each of the reference fingerprint regions includes one or more acquired fingerprint features.

In an embodiment, the program instructions, when executed by the processor, cause the device to perform the operation of: acquiring a plurality of reference fingerprint images or fingerprint features while the finger performs the arc-shaped sliding from a first position to a second position on the fingerprint identifier, where the first position and the second position are respectively located on two sides of a preset midline of the fingerprint identifier, and an angle between the first position and the second position is greater than or equal to a preset angle.

In a third aspect, the present disclosure further provides a mobile device for fingerprint authentication, comprising: a fingerprint identifier arranged on a side edge of the mobile device and configured to receive an enrolled target fingerprint region; a memory configured to store a fingerprint database, where the fingerprint database stores a plurality of reference fingerprint regions formed during fingerprint acquisition of a finger performing arc-shaped sliding on a fingerprint identifier, and each of the reference fingerprint regions has a corresponding fingerprint feature; and a processor connected to the memory and configured to perform the operations of: obtaining a target fingerprint region to be authenticated, where the target fingerprint region includes at least one first fingerprint feature set; judging, according to the at least one first fingerprint feature set and fingerprint feature sets included in a plurality of reference fingerprint regions of a fingerprint database, whether a primary reference fingerprint region associated with the target fingerprint region is included in the fingerprint database; and determining, based on a judgment result, whether the target fingerprint region passes the authentication.

In a fourth aspect, the present disclosure provides a non-transitory computer-readable medium having stored thereon program instructions for fingerprint authentication, which, when executed by at least one processor, cause to implement the operations of: obtaining a target fingerprint region to be authenticated, where the target fingerprint region includes at least one first fingerprint feature set; judging, according to the at least one first fingerprint feature set and fingerprint feature sets included in a plurality of reference fingerprint regions of a fingerprint database, whether a primary reference fingerprint region associated with the target fingerprint region is included in the fingerprint database, where the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature; and determining, based on a judgment result, whether the target fingerprint region passes the authentication.

Based on the above description about the solutions of the present disclosure, those skilled in the art will understand that in the solutions provided in the above embodiments, a plurality of reference fingerprint regions can be acquired in a swiping mode (by a finger performing arc-shaped sliding), which is faster than the mode of implementing fingerprint enrollment through multiple times of pressing in the prior art, thereby improving the efficiency in fingerprint enrollment. In view of this, in the technical solutions of the present disclosure, the association between the reference fingerprint regions may be used in authentication of the target fingerprint region, so that the target fingerprint region does not need to be compared with each reference fingerprint region, and therefore, the authentication process can be simplified while ensuring accuracy of the authentication result, thereby speeding up the fingerprint authentication.

### BRIEF DESCRIPTION OF THE DRAWINGS

Above and other objectives, features and advantages of the exemplary embodiments of the present disclosure will become readily apparent from the following detailed description, which proceeds with reference to the accompanying drawings. In the accompanying drawings, several embodiments of the present disclosure are illustrated by way of example rather than limitation, and identical or corresponding reference numerals indicate identical or corresponding parts, in which:

FIG. 1 is a schematic flowchart of a method for fingerprint authentication according to an embodiment of the present disclosure;

FIG. 2 is a schematic flowchart of another method for fingerprint authentication according to an embodiment of the present disclosure;

FIG. 3 is a schematic flowchart of a method for establishing a fingerprint database according to an embodiment of the present disclosure;

FIG. 4 is a schematic flowchart of another method for establishing a fingerprint database according to an embodiment of the present disclosure;

FIG. 5 is a perspective view of a plurality of reference fingerprint images in a fingerprint database according to an embodiment of the present disclosure;

FIG. 6A is a schematic flowchart of a method for determining a secondary reference fingerprint region according to an embodiment of the present disclosure;

FIG. 6B is a schematic flowchart of another method for determining a secondary reference fingerprint region according to an embodiment of the present disclosure;

FIG. 7 is a schematic flowchart of a method for determining whether the target fingerprint region passes the authentication according to an embodiment of the present disclosure;

FIG. 8 is a schematic flowchart of another method for determining whether the target fingerprint region passes the authentication according to an embodiment of the present disclosure;

FIG. 9 is a block diagram of a device for fingerprint authentication according to an embodiment of the present disclosure; and

FIG. 10 is a block diagram of a mobile device for fingerprint authentication according to an embodiment of the present disclosure.

### DETAIL DESCRIPTION OF THE INVENTION

The technical solutions in the embodiments of the present disclosure will be clearly and completely described below with reference to the accompanying drawings in the embodiments of the present disclosure. Obviously, the described embodiments are only some, but not all, of the embodiments of the present disclosure. All other embodiments, which can be derived by those skilled in the art from the embodiments of the present disclosure without making any creative effort, shall fall within the protection scope of the present disclosure.

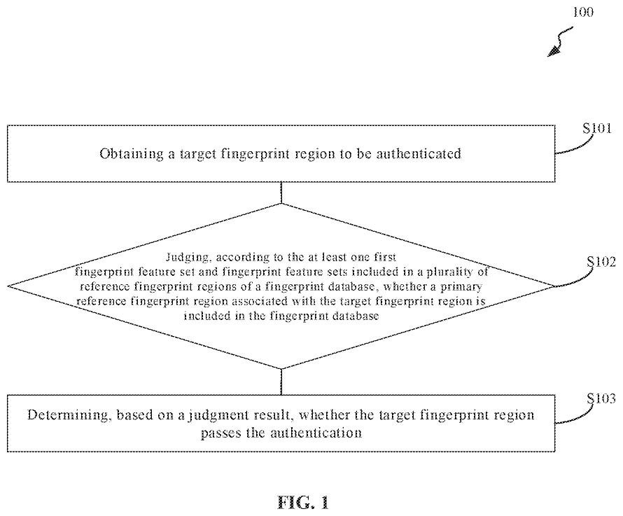

FIG. 1 is a schematic flowchart of a method 100 for fingerprint authentication according to an embodiment of the present disclosure.

As shown in FIG. 1, the method 100 may comprise, at step S101, obtaining a target fingerprint region to be authenticated. In an implementation scenario, the target fingerprint region to be authenticated may be acquired by a fingerprint identifier on an electronic device (for example, a mobile device) and transmitted to the electronic device for authentication. The target fingerprint region may be a fingerprint region acquired by the fingerprint identifier when a finger is pressed or swiped against the fingerprint identifier. For fingerprint identifiers with different sensing areas, the acquired fingerprint region may differ. For example, for a fingerprint identifier with a smaller sensing area, the target fingerprint region may be a part of a complete fingerprint (e.g., a part of a thumbprint) of the authenticated person, while for a fingerprint identifier with a larger sensing area, the target fingerprint region may be a complete fingerprint (e.g., a complete thumbprint) of the authenticated person. Specifically, the target fingerprint region may be a fingerprint image.

In order to facilitate the comparison and authentication with reference fingerprint regions in a fingerprint database, the target fingerprint region has a plurality of fingerprint feature sets, which may include at least one first fingerprint feature set, for example. The number of first fingerprint feature sets may be set to one, two, three, or the like as desired. Each first fingerprint feature set may include one or more (e.g., 2, 3, or the like) fingerprint features (feature points of a fingerprint), and the specific number of fingerprint features included may be set as desired.

After obtaining the target fingerprint, the method 100 may comprise, at step S102, judging, according to the at least one first fingerprint feature set and fingerprint feature sets included in a plurality of reference fingerprint regions of a fingerprint database, whether a primary reference fingerprint region (one of the plurality of reference fingerprint regions) associated with the target fingerprint region is included in the fingerprint database. Based on different application scenarios, some or all of the first fingerprint feature sets may be used to judge whether the fingerprint database includes a primary reference fingerprint region associated with the target fingerprint region. Further, in order to facilitate the fingerprint authentication, the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature.

It will be appreciated that image acquisition may be performed when a finger performs arc-shaped sliding on the fingerprint identifier, so that a plurality of reference fingerprint images may be acquired. The reference fingerprint images may be acquired in a manner the same as or similar to the fingerprint image corresponding to the target fingerprint region, such as also by pressing or swiping a finger against the fingerprint identifier, and may also be a part of a complete fingerprint or a complete fingerprint depending on the sensing area of the fingerprint identifier.

In an implementation, each of the acquired reference fingerprint images may be used as a reference fingerprint region. In other words, each of the reference fingerprint regions may correspond to one of the acquired reference fingerprint images.

In another implementation, based on fingerprint features in the acquired reference fingerprint image, the fingerprint features may be divided into a plurality of reference fingerprint regions. In other words, each reference fingerprint region may include one or more acquired fingerprint feature sets. In this case, the number of fingerprint features in each fingerprint feature set is not fixed, and may include, for example, 1, 2, or more fingerprint features.

In an embodiment, each of the acquired reference fingerprint images may be pre-processed to extract fingerprint features therefrom to obtain all fingerprint features. During the fingerprint extraction, information such as positions (such as coordinates), angles, and properties (such as shapes, trends or textures) of these fingerprint features may be obtained simultaneously. Then, all the fingerprint features may be divided into a plurality of reference fingerprint regions according to a preset rule. The preset rule herein may be, for example, the number of fingerprint features included in each reference fingerprint region, a selection mode of the fingerprint features, and the like. Further, the selection mode of the fingerprint features may be determined according to a distance between the fingerprint features (a position difference between the fingerprint features) and/or a rotation angle between the fingerprint features (an angle difference between the fingerprint features). For example, a preset number of fingerprint features with a shorter distance and/or a smaller rotation angle may be combined into one reference fingerprint region.

In an embodiment, the primary reference fingerprint region associated with the target fingerprint region may be understood as a reference fingerprint region with a common fingerprint feature with the first fingerprint feature set. The common fingerprint feature herein refers to that the comparison between the fingerprint feature set in the reference fingerprint region and a similar fingerprint feature in the first fingerprint feature set meets a certain condition, which may be specifically determined by: comparing features of the plurality of reference fingerprint regions stored in the fingerprint database with the first fingerprint feature set in a preset sequence, respectively (i.e., comparing the fingerprint feature sets in the plurality of reference fingerprint regions with the first fingerprint feature set, respectively) to obtain a comparison result, where the preset sequence herein may be an acquisition sequence of the reference fingerprint images; confirming, when the comparison result meets a preset condition, that the fingerprint database includes a primary reference fingerprint region associated with the target fingerprint region; and accordingly confirming, when the comparison result does not meet the preset condition, that the fingerprint database does not include a primary reference fingerprint region associated with the target fingerprint region.

The feature comparison in this embodiment may be a similarity comparison, and the comparison result may be a similarity score. At this time, whether the comparison result meets the preset condition may be determined through a comparison with a score threshold or threshold range. For example, it may be set that when the similarity score is greater than or equal to a score threshold or within a score threshold range, the preset condition is met. Accordingly, it may be set that when the similarity score is smaller than the score threshold or beyond the score threshold range, the preset condition is not met.

Next, the method 100 may proceed to step S103, determining, based on a judgment result, whether the target fingerprint region passes the authentication. It will be appreciated that when the fingerprint database includes a primary reference fingerprint region associated with the target fingerprint region, it may be determined that the target fingerprint region has a probability of passing the authentication, and therefore, the association between the reference fingerprint regions may be further used in authentication of the target fingerprint region, whereas when the fingerprint database does not include a primary reference fingerprint region associated with the target fingerprint region, it may be directly determined that the target fingerprint region cannot pass the authentication, which means that the authentication is failed.

It can be seen that in the solution of the present disclosure, a plurality of reference fingerprint regions can be acquired in a swiping mode (by a finger performing arc-shaped sliding), which is faster than the mode of implementing fingerprint enrollment through multiple times of pressing in the prior art, thereby improving the efficiency in fingerprint enrollment. In view of this, in the solution of the present disclosure, the association between the reference fingerprint regions may be further used in authentication of the target fingerprint region, so that the target fingerprint region does not need to be compared with each reference fingerprint region, and therefore, the authentication process can be simplified while ensuring accuracy of the authentication result, thereby speeding up the fingerprint authentication.

It will be appreciated that the plurality of reference fingerprint regions obtained by the above acquisition method of the reference fingerprint image have certain correlation, which may be embodied that the relative positional relation of some reference fingerprint regions meets a preset condition, while the relative positional relation of some other reference fingerprint regions does not meet the preset condition. The relative positional relation herein may be, for example, a distance and/or a rotation angle.

It will be appreciated that the associated fingerprint features are more likely to be present among a plurality of reference fingerprint regions with a smaller distance and/or rotation angle, and the smaller the distance or the rotation angle is, the greater the likelihood of associated fingerprint features present in the reference fingerprint regions will be, and the more associated fingerprint features will exist. In view of this, the fingerprint authentication can be more accurately performed with these associated reference fingerprint regions, and the accuracy of the fingerprint authentication can be determined with those non-associated reference fingerprint regions (which will be described in detail later).

In addition, the target fingerprint region may further include a second fingerprint feature set. The number of second fingerprint feature sets may be set to one, two, three, or the like as desired, and similarly, each second fingerprint feature set may include, as desired, one or more (e.g., 3, 4, or the like) fingerprint features.

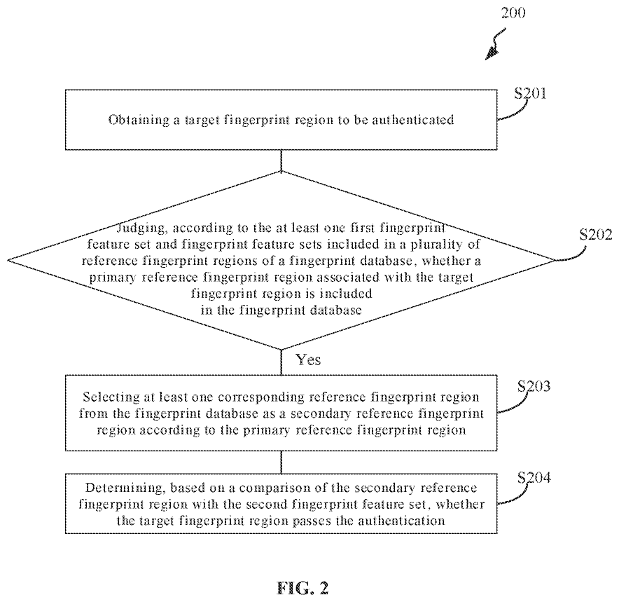

Based on the above characteristics, FIG. 2 exemplarily shows a schematic flowchart of another method for fingerprint authentication according to an embodiment of the present disclosure. For the steps S201 and S202 therein, reference may be made to the description of the foregoing embodiments, and are not repeated here. After determining the judgment result that the fingerprint database includes a primary reference fingerprint region associated with the target fingerprint region, the method 200 may determine whether the target fingerprint region passes the authentication through steps S203 and S204.

As shown in FIG. 2, at step S203, in response to the judgment result that the fingerprint database includes a primary reference fingerprint region associated with the target fingerprint region, at least one corresponding reference fingerprint region is selected from the fingerprint database as a secondary reference fingerprint region according to the primary reference fingerprint region. In an implementation scenario, a reference fingerprint region having a relative positional relation with the primary reference fingerprint region that meets a preset condition may be selected as the secondary reference fingerprint region, to facilitate accurate fingerprint authentication. For example, a reference fingerprint region with a distance from the primary reference fingerprint region within a preset distance range and/or with a rotation angle from the primary reference fingerprint region within a preset angle range is selected as the secondary reference fingerprint region. The selection method will be described in detail later.

Next, at step S204, the method 200 may comprise determining, based on a comparison of the secondary reference fingerprint region with the second fingerprint feature set, whether the target fingerprint region passes the authentication. The comparison herein may also be a similarity comparison.

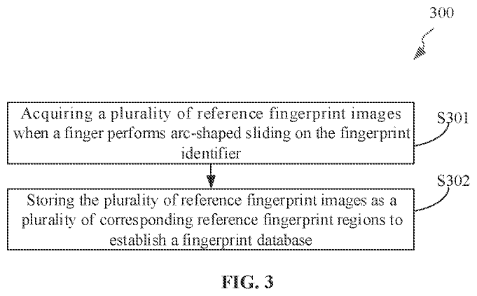

It can be seen that in the solution of the present disclosure, the association between reference fingerprint regions may be further used in authentication of the target fingerprint region by selecting the associated reference fingerprint regions (the primary reference fingerprint region and the secondary reference fingerprint region), so that the target fingerprint region does not need to be compared with each reference fingerprint region, and therefore, the authentication process can be simplified while ensuring accuracy of the authentication result, thereby speeding up the fingerprint authentication. In order to facilitate a full understanding of the fingerprint database in the present disclosure, the establishment process of the fingerprint database will be further described below in conjunction with FIG. 3 and the like. FIG. 3 shows a method for establishing a fingerprint database when each reference fingerprint region corresponds to one acquired reference fingerprint image.

As shown in FIG. 3, before obtaining the target fingerprint region to be authenticated, a method 300 may further comprise, at step S301, acquiring a plurality of reference fingerprint images when a finger performs arc-shaped sliding on the fingerprint identifier. The acquiring the plurality of reference fingerprint images may comprise acquiring a plurality of reference fingerprint images while a finger (such as the thumb) performs arc-shaped sliding from a first position to a second position on the fingerprint identifier, where the first position and the second position may be respectively located on two sides of a preset midline of the fingerprint identifier. Specifically, the first position and the second position may be symmetrical with the preset midline of the fingerprint identifier as an axis of symmetry, which has a sliding mode more consistent with sliding habits of fingers, and thus can facilitate fingerprint acquisition. In addition, the first position and the second position may be asymmetrical.

In order to acquire a sufficient number of reference fingerprint images for accurate fingerprint authentication, an angle between the first position and the second position may be greater than or equal to a preset angle, which may be, for example, between 8° and 20°. In an implementation, a preset displacement may be determined according to the number of acquired fingerprints, a speed of the user finger sliding, a magnitude of the finger action, and the like, and according to the preset displacement, a size of the angle is determined, which is generally 8° to 20°. Taking the case where the number of acquired fingerprints is used as a setting basis as an example, when a larger number of reference fingerprint images are desired to be acquired, the angle may be set to be larger, for example, 15°, 17°, 19°, or the like. Accordingly, when a smaller number of reference fingerprint images are desired to be acquired, the angle may be set to be smaller, for example 8°, 10° or 13°.

The number of reference fingerprint images acquired in the solution of the present disclosure may be specifically set according to different requirements on the accuracy of the fingerprint authentication result, and is typically between 8 and 30. For example, in case of a higher requirement on the accuracy of the fingerprint authentication result, a larger number of reference fingerprint images, such as 24, 27, or 29 reference fingerprint images, may be acquired. Accordingly, in case of a lower requirement on the accuracy of the fingerprint authentication result, a smaller number of reference fingerprint images, such as 8, 10, or 17 reference fingerprint images, may be acquired.

In addition, the number of the acquired reference fingerprint images may also vary according to different electronic devices. For example, when the electronic device is a mobile phone, 8 to 16 reference fingerprint images may be acquired, and when the electronic device is a portable computer or an electronic lock, for example, 20 to 30 reference fingerprint images may be acquired (specifically, the number may be set according to market requirements or user requirements).

Based on difference numbers of the acquired reference fingerprint images, the solution of the present disclosure may select fingerprint identifiers with different identification speeds to acquire fingerprints at different frequencies. For example, when a larger number of reference fingerprint images are desired to be acquired, a fingerprint identifier with a higher identification speed may be selected for fingerprint acquisition at a frequency of, for example, 8 to 9 milliseconds. Accordingly, when a smaller number of reference fingerprint images are desired to be acquired, a fingerprint identifier with a lower identification speed may be selected for fingerprint acquisition at a frequency of, for example, 25 to 30 milliseconds.

In order to facilitate installation on an electronic device of a smaller size, in the solution of the present disclosure, a rectangular fingerprint identifier may be adopted and installed on a side edge of the electronic device. When the fingerprint identifier is installed on the side edge of the electronic device, long edges of the fingerprint identifier may correspond to a longer edge direction of side edges of the electronic device, and wide edges of the fingerprint identifier may correspond to a wide edge direction of the side edges of the electronic device. Further, in order to meet the installation requirement, a width of the fingerprint identifier may be set to be smaller, for example, less than or equal to 1.8 mm, and specifically, may be 1.5 mm. Based on such an installation mode of the fingerprint identifier, and in order to facilitate fingerprint acquisition, the above preset midline may be a midline of a shorter edge of the fingerprint identifier. The fingerprint identifier installed on the side edge of the electronic device can not only adapt to the smaller volume requirement of the electronic device, but also perform fingerprint acquisition with a finger of a hand that holds the electronic device, so that the other hand of the user can be free and the user experience can be promoted.

After the plurality of reference fingerprint images are obtained, the flow returns to the method 300. The method 300 may comprise, at step S302, storing the plurality of reference fingerprint images as a plurality of corresponding reference fingerprint regions to establish a fingerprint database.

The above describes, in conjunction with embodiments, the method for establishing a fingerprint database when each reference fingerprint region corresponds to one acquired reference fingerprint image. It will be appreciated that the above method is merely exemplary and not limiting, and other settings or changes may be made by those skilled in the art as desired. For example, a different angle, such as 70°, 90°, 150°, or the like, between the first position and the second position may be adopted, and other numbers of the acquired reference fingerprint images, such as 6, 16, 20, 30, or the like, may be acquired.

For the case where each reference fingerprint region includes one or more acquired fingerprint features, the method for establishing the fingerprint database may comprise acquiring a plurality of fingerprint features when the finger performs arc-shaped sliding on the fingerprint identifier with reference to the method as described in the foregoing embodiments, and setting and storing the plurality of fingerprint features as a plurality of corresponding reference fingerprint regions to establish a fingerprint database. The method for acquiring the plurality of fingerprint features, or the like, may be the same as or similar to the method described in the foregoing embodiments, and thus will not be described in detail here.

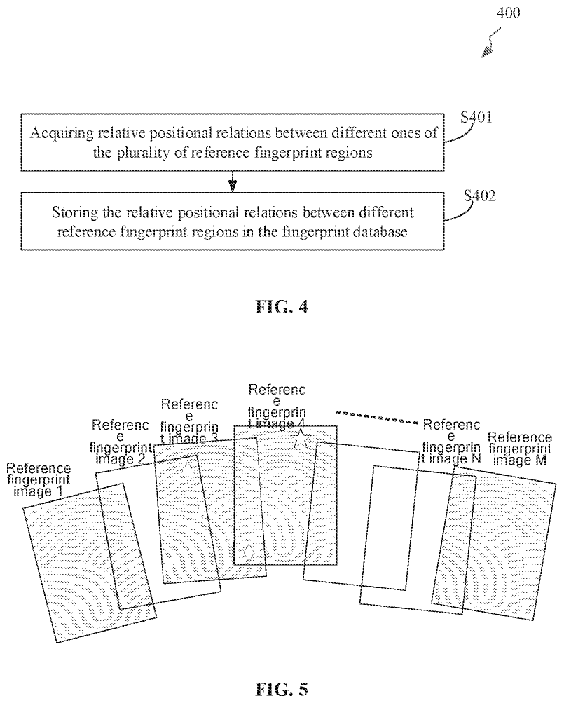

As can be seen from the foregoing description of the embodiments, a secondary reference fingerprint region may be determined from relative positional relations between different reference fingerprint regions in the fingerprint database, and to facilitate utilization of the relative positional relation, the relative positional relations between different reference fingerprint regions may also be stored in the fingerprint database. Specifically, as shown in FIG. 4, after obtaining the plurality of reference fingerprint regions, a method 400 may further comprise, at step S401, acquiring relative positional relations between different ones of the plurality of reference fingerprint regions. The relative positional relations may include distances and rotation angles between different reference fingerprint regions.

It will be appreciated that after a reference fingerprint image is acquired, a position and/or angle of the image may be recorded, and a position and/or angle of a fingerprint feature therein may be further recorded. In this embodiment, the position of the reference fingerprint image may be obtained by a preset method from coordinates (e.g., x-coordinate and y-coordinate in a two-dimensional coordinate system) of each fingerprint feature, or may be directly obtained at the time of acquisition (e.g., the coordinates of the reference fingerprint image are obtained directly). Likewise, when each reference fingerprint region includes one or more acquired fingerprint features, the position of the reference fingerprint region may also be obtained by a preset method from coordinates (e.g., x-coordinate and y-coordinate in a two-dimensional coordinate system) of the fingerprint feature contained in the image.

Similarly to the position, the angle of the reference fingerprint image may also be obtained by a preset method from angles of fingerprint features in the image or directly obtained upon acquisition. When each reference fingerprint region includes one or more acquired fingerprint features, the angle may also be obtained by a preset method from an angle of each fingerprint feature contained in the image.

The preset methods for acquiring the position and the angle may be set and selected as desired, and are not described in detail here.

In an implementation scenario, the angle of the fingerprint feature may be obtained from a position of the fingerprint feature. Specifically, an x-axis gradient, dx, and a y-axis gradient, dy, of each fingerprint feature may be calculated from the coordinates of each fingerprint feature. Next, the angle of each fingerprint feature may be calculated by equation (1) from the gradients of each fingerprint feature:

$$Kpm\_alg = {tan}^{- 1} \frac{d x}{d y} \qquad ( 1 )$$

where Kpm_{_alg} is the angle of the fingerprint feature.

After the position and the angle of each reference fingerprint region are obtained, a distance and a rotation angle between each reference fingerprint region and each other reference fingerprint region may be determined from the position and the angle of the reference fingerprint region. The method for calculating the distance and rotation angle between the reference fingerprint images will be explained below in this solution with reference to FIG. 4, which shows m reference fingerprint images (reference fingerprint image 1, reference fingerprint image 2, reference fingerprint image 3, reference fingerprint image 4, . . . , reference fingerprint image N, and reference fingerprint image M, respectively).

Taking the reference fingerprint image 3 and the reference fingerprint image 4 as an example, the reference fingerprint image 3 and the reference fingerprint image 4 may be compared to determine similar fingerprint features (such as the diamond-shaped fingerprint feature in the overlapping region of the reference fingerprint image 3 and the reference fingerprint image 4 in the figure) between the reference fingerprint image 3 and the reference fingerprint image 4, and dissimilar fingerprint features are also found in the reference fingerprint image 4 and the reference fingerprint image 3, respectively, such as the triangular fingerprint feature in the upper left corner of the reference fingerprint image 3, and the pentagram fingerprint feature in the upper right corner of the reference fingerprint image 4.

Next, a distance between the triangular fingerprint feature and the pentagram fingerprint feature is calculated from the positions of the diamond fingerprint feature, the triangular fingerprint feature, and the pentagram fingerprint feature. For example, a distance between the triangular fingerprint feature and the diamond fingerprint feature, and a distance between the pentagram fingerprint feature and the diamond fingerprint feature, are firstly calculated, from which the distance between the triangular fingerprint feature and the pentagram fingerprint feature is then calculated, and thereby a distance between the reference fingerprint image 4 and the reference fingerprint image 3 is determined.

According to the above method, a distance between any two reference fingerprint images can be calculated, such as a distance between the reference fingerprint image 1 and the reference fingerprint image 2, a distance between the reference fingerprint image 2 and the reference fingerprint image 3, a distance between the reference fingerprint image N and the reference fingerprint image M, . . . , which are not described one by one herein.

In calculation of the rotation angle, a similar method to the above-described method for calculating the distance between two reference fingerprint images may be adopted. Still taking the reference fingerprint image 4 and the reference fingerprint image 3 as an example, an angle difference between the triangular fingerprint feature and the pentagram fingerprint feature may be calculated from an angle of the diamond fingerprint feature, an angle of the triangular fingerprint feature and an angle of the pentagram fingerprint feature, and based on this angle difference, an angle difference between the reference fingerprint image 4 and the reference fingerprint image 3 is determined and taken as a rotation angle between the two reference fingerprint images.

According to the above method, a rotation angle between any two reference fingerprint images can be calculated, such as a rotation angle between the reference fingerprint image 1 and the reference fingerprint image 2, a rotation angle between the reference fingerprint image 2 and the reference fingerprint image 3, a rotation angle between the reference fingerprint image N and the reference fingerprint image M, . . . , which are not described one by one herein.

From the above description, it will be appreciated that in the solution of the present disclosure, an overlapping region of different reference fingerprint images is determined from similar fingerprint features, and based on dissimilar fingerprint features in the different reference fingerprint images, distances and rotation angles of these dissimilar fingerprint features are obtained, thereby determining distances and rotation angles between different reference fingerprint images.

The above describes the methods for calculating distances and rotation angles between reference fingerprint images. Likewise, when each reference fingerprint region includes one or more fingerprint features, a similar method may be adopted to calculate distances and rotation angles between different reference fingerprint regions. For example, the distances between different reference fingerprint regions may be calculated from positions of the reference fingerprint regions, and the rotation angles between different reference fingerprint regions may be calculated from angles of the reference fingerprint regions, which will not be described in detail here.

The above describes the method for obtaining the relative positional relations of the reference fingerprint regions with reference to the embodiments. It will be appreciated that the above method is merely exemplary and not limiting, and variations and modifications may be made as desired by those skilled in the art. For example, the reference fingerprint images and the positions and angles of the reference fingerprint regions may be obtained by other methods, and the distances, rotation angles, and the like between different reference fingerprint regions may be also calculated by other methods.

After obtaining the relative positional relation between different reference fingerprint regions, the method 400 may comprise, at step S402, storing the relative positional relations between different reference fingerprint regions in the fingerprint database.

Since the relative positional relations between different reference fingerprint regions are stored in the fingerprint database, the relative positional relations may be used in selection of the secondary reference fingerprint region, thereby improving the efficiency in the fingerprint authentication.

In an embodiment, at least one reference fingerprint region having a relative positional relation with the primary reference fingerprint region that meets a first preset condition may be selected from the fingerprint database, and taken as the secondary reference fingerprint region. For example, another reference fingerprint region with a distance from the primary reference fingerprint region within a preset distance range and/or with a rotation angle within a preset angle range may be selected as the secondary reference fingerprint region. The preset distance range and the preset angle range may be set according to different requirements. For example, the preset distance range may be set to be larger than 140 μm, in an example, such as 140 μm to 300 μm, and the preset angle range may be 8° to 20°, or the like.

The number of the selected secondary reference fingerprint regions may be determined as desired. For example, only one reference fingerprint region within the above preset distance range and closest to the primary reference fingerprint region and/or within the preset angle range and having the smallest rotation angle to the primary reference fingerprint region may be selected as the secondary reference fingerprint region, so that the comparison speed can be increased while ensuring accuracy in the fingerprint authentication. In addition, a plurality of reference fingerprint regions within the preset distance range and/or within the preset angle range may be collectively used as the secondary reference fingerprint region, thereby improving the accuracy in the fingerprint authentication.

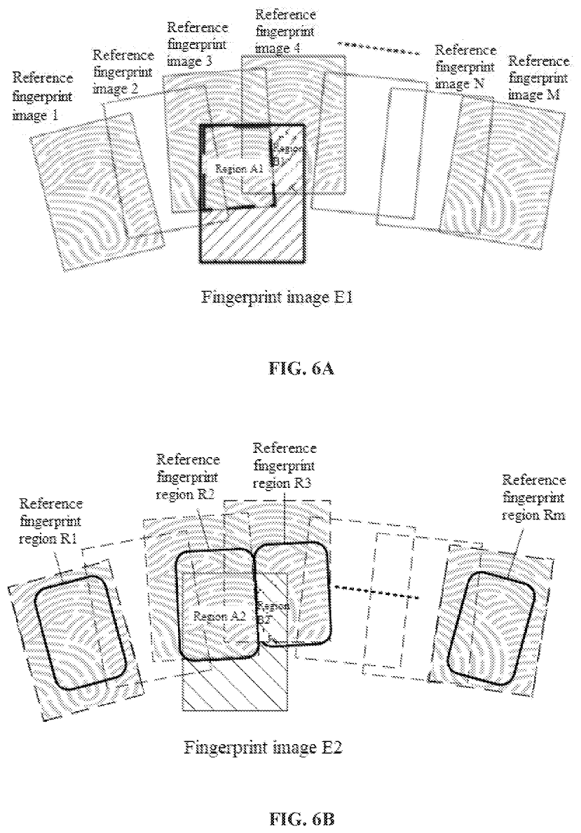

In order to fully illustrate the selection of the secondary reference fingerprint region, the present solution will be described in detail below in conjunction with FIGS. 6A and 6B. FIG. 6A shows selection of the secondary reference fingerprint regions in the case where each reference fingerprint region corresponds to one reference fingerprint image, while FIG. 6B shows selection of the secondary reference fingerprint regions in the case where each reference fingerprint region includes the acquired fingerprint features.

In FIG. 6A, the fingerprint image E1 is the target fingerprint region, and the reference fingerprint image 3 is set to be the primary reference fingerprint region, where a region A1 (which is an overlapping region of the fingerprint image E1 and the reference fingerprint image 3, the trapezoid frame indicated by dotted lines in the figure) is compared with the target fingerprint region (in other words, it has a common fingerprint feature with the first feature set).

It can be seen that each of the second fingerprint feature sets (the hatched region in the figure) of the fingerprint image E1 is located right and below the first fingerprint feature set (the fingerprint set in the overlapping region of the fingerprint image E1 and the region A1), so that the reference fingerprint image 4, which is located right and below the reference fingerprint image 3 and has a relative positional relation with the reference fingerprint image 3 meeting the aforementioned condition, may be selected as the secondary reference fingerprint region. As can be seen from FIG. 6A, in this embodiment, there is only an overlapping region (region B1) between the reference fingerprint image 4 and the second fingerprint feature set on the right side. In a subsequent comparison, by comparing the region B1 in the reference fingerprint image 4 and the overlapped second fingerprint feature set, an authentication result of the target fingerprint region can be obtained.

For the above embodiment, if the fingerprint image E1 further includes a third fingerprint feature set (not shown in the figure, which may be understood as another second fingerprint feature set) located at the right side of the second fingerprint feature set, the reference fingerprint image 4 and the reference fingerprint image 5 (not shown in the figure) may both be taken as secondary reference fingerprint regions. As can be seen from the foregoing description, in order to improve the authentication efficiency, it is also possible to take merely the reference fingerprint image 4 as the secondary reference fingerprint region.

It will be appreciated that with the design of the primary reference fingerprint region and the secondary reference fingerprint region, the present disclosure may reduce useless repeated comparisons, thereby improving the efficiency in the fingerprint authentication.

FIG. 6B exemplarily shows one arrangement of the reference fingerprint regions. Those skilled in the art may provide more or less reference fingerprint regions as desired, and positions of the reference fingerprint regions may also be set as desired.

In FIG. 6B, the fingerprint image E2 is the target fingerprint region, and the reference fingerprint regions include a reference fingerprint region R1, a reference fingerprint region R2, a reference fingerprint region R3, . . . , and a reference fingerprint region Rm. The plurality of rectangular dashed boxes in the figure may represent reference fingerprint images from which fingerprint features are extracted. In this case, a plurality of fingerprint features, rather than the whole reference fingerprint image, are stored. The reference fingerprint region R2 is set to be the primary reference fingerprint region, where a region A2 (which is an overlapping region of the fingerprint image E2 and the reference fingerprint region R2) is compared with the target fingerprint region.

It can be seen that each of the second fingerprint feature sets (the hatched region in the figure) of the fingerprint image E2 is located right and below the first fingerprint feature set (the fingerprint set in the overlapping region of the fingerprint image E2 and the region A2), so that the reference fingerprint region R3, which is located right and below the reference fingerprint region R2 and has a relative positional relation with the reference fingerprint region R2 meeting the aforementioned condition, may be selected as the secondary reference fingerprint region. As can be seen from FIG. 6B, in this embodiment, there is only an overlapping region (region B2) between the reference fingerprint region R3 and the reference fingerprint region R2, so that the reference fingerprint region R3 is taken as the secondary reference fingerprint region.

In a subsequent comparison, by comparing the region B2 in the reference fingerprint region R3 and the overlapped second fingerprint feature set, an authentication result of the target fingerprint region can be obtained.

For the above embodiment, if the fingerprint image E2 further includes a third fingerprint feature set (not shown in the figure, which may be understood as another second fingerprint feature set) located at the right side of the second fingerprint feature set, the reference fingerprint region R3 and the reference fingerprint region R4 (not shown in the figure) may both be taken as secondary reference fingerprint regions. In addition, it is also possible to take merely the reference fingerprint region R3 as the secondary reference fingerprint region. Similarly to the previous embodiment, in selection of the secondary reference region, it is also possible to select only a reference fingerprint region that has not been compared with the target fingerprint region as the secondary reference fingerprint region.

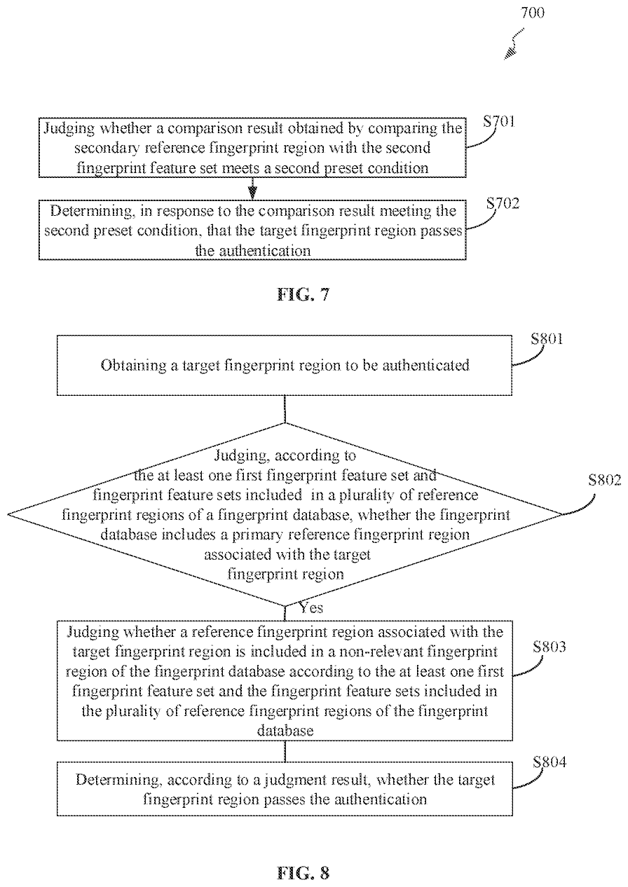

The above describes the method for selecting the secondary reference fingerprint region with reference to the embodiments. Two methods for authenticating the target fingerprint region will be explained below in conjunction with FIGS. 7 and 8.

In the embodiment as shown in FIG. 7, a method 700 comprises, at step S701, judging whether a comparison result obtained by comparing the secondary reference fingerprint region with the second fingerprint feature set meets a second preset condition. The comparison result herein may be a similarity score, and the second preset condition may include that the similarity score is greater than or equal to a score threshold or within a score threshold range. In view of this, it may be set that when the similarity score is greater than or equal to a score threshold or within a score threshold range, the second preset condition is met. Accordingly, it may be set that when the similarity score is smaller than the score threshold or beyond the score threshold range, the second preset condition is not met.

Next, at step S702, the method 700 comprises determining, in response to the comparison result meeting the second preset condition, that the target fingerprint region passes the authentication. For the case that the comparison result is a similarity score, and the second preset condition includes that the similarity score is greater than or equal to a score threshold or within a score threshold range, it is determined that the target fingerprint region passes the authentication in response to the similarity score corresponding to the comparison result greater than or equal to the score threshold or within the score threshold range. Accordingly, it is determined that the target fingerprint region fails to pass the authentication in response to the similarity score corresponding to the comparison result smaller than the score threshold or beyond the score threshold range.

For the aforementioned embodiment as shown in FIG. 6A, it is determined that the target fingerprint region passes the authentication when a similarity score between the region B1 and the overlapped second fingerprint feature set is greater than or equal to the score threshold or within the score threshold range; and accordingly, it is determined that the target fingerprint region fails to pass the authentication when the similarity score between the region B1 and the overlapped second fingerprint feature set is smaller than the score threshold or beyond the score threshold range.

It can be seen that in the solution of the present disclosure, whether the secondary reference fingerprint region is matched with the second fingerprint feature set of the target fingerprint region is judged through feature comparison, which is accurate and reliable, and therefore can guarantee the accuracy of the authentication result.

It will be appreciated that in some scenarios (e.g., electronic device failure), there may be the case where a non-relevant fingerprint region poorly associated with the primary reference fingerprint region also passes the comparison with the target fingerprint region. In order to prevent such cases and further ensure the accuracy of the authentication result, the fingerprint authentication in the present solution may be performed by the method as shown in FIG. 8.

As shown in FIG. 8, a method 800 may comprise, at step S801, obtaining a target fingerprint region to be authenticated. Next, at step S802, according to the at least one first fingerprint feature set and fingerprint feature sets included in a plurality of reference fingerprint regions of a fingerprint database, it is judged whether the fingerprint database includes a primary reference fingerprint region associated with the target fingerprint region. Steps S801 and S802 are the same as steps S101 and S102 as described above. The related description may refer to the foregoing embodiments, which is not described in detail here.

Further, at step S803, in response to the judgment result that the fingerprint database includes a primary reference fingerprint region associated with the target fingerprint region, it is judged whether a reference fingerprint region associated with the target fingerprint region is included in a non-relevant fingerprint region of the fingerprint database according to the at least one first fingerprint feature set and the fingerprint feature sets included in the plurality of reference fingerprint regions of the fingerprint database.

The non-relevant fingerprint region may be a reference fingerprint region in the fingerprint database that has a relative positional relation with the primary reference fingerprint region meeting a third preset condition. The third preset condition may include that the distance is greater than a maximum distance value in the preset distance range, and/or the rotation angle is greater than a maximum angle value in the preset angle range. For the embodiment as shown in FIG. 6A, the reference fingerprint image N and the reference fingerprint image M, which are further away and/or have a larger rotation angle from the reference fingerprint image 3, may be taken as non-relevant fingerprint regions. For the embodiment as shown in FIG. 6B, the reference fingerprint regions Rn (not shown in the figure) and the reference fingerprint regions Rm, which are further away and/or have a larger rotation angle from the reference fingerprint region R2, may be taken as non-relevant fingerprint regions.

The method for judging whether the reference fingerprint region associated with the target fingerprint region is included may refer to the description of the foregoing embodiments, and will not be described in detail here.

Next, at step S803, the method 800 may comprise determining, according to a judgment result, whether the target fingerprint region passes the authentication. In an embodiment, in response to the judgment result that the non-relevant fingerprint region includes a reference fingerprint region associated with the target fingerprint region, it may be determined that the target fingerprint region fails to pass the authentication. Also taking FIG. 6A as an example, when the reference fingerprint image N or the reference fingerprint image M is associated with the target fingerprint region, it may be determined that the target fingerprint region fails to pass the authentication. It can be seen that with the solution of the present disclosure, misjudgment caused by electronic device faults and the like can be avoided, and the accuracy of the fingerprint authentication result can be further ensured.

In order to further ensure the accuracy of the authentication result, the solution of the present disclosure further provides another embodiment to judge whether the target fingerprint region passes the authentication. Specifically, the embodiment may comprise: taking, in response to the judgment result that the non-relevant fingerprint region includes a reference fingerprint region associated with the target fingerprint region, the reference fingerprint region as an authenticated reference fingerprint region (which may be understood as a primary reference fingerprint region from the non-relevant fingerprint regions), and selecting at least one corresponding reference fingerprint region from the non-relevant fingerprint regions as the secondary reference fingerprint region according to the authenticated reference fingerprint region. The method for determining the primary reference fingerprint region and the method for selecting the secondary reference fingerprint region may refer to the description of the foregoing embodiments, and are not described in detail here. Also taking FIG. 6A as an example, when the reference fingerprint image N is the authenticated reference fingerprint region, the reference fingerprint image M is set to be the secondary reference fingerprint region.

Then, the present embodiment may comprise determining, based on a comparison of the secondary reference fingerprint region with the second fingerprint feature set, whether the target fingerprint region passes the authentication. The method for judging whether the authentication is passed may also refer to the description of the foregoing embodiments, and may specifically comprise: first judging whether a comparison result obtained by comparing the secondary reference fingerprint region with the second fingerprint feature set meets a fourth preset condition, and then determining, in response to the comparison result meeting the fourth preset condition, that the target fingerprint region fails to pass the authentication.

The comparison result herein may also be a similarity score, and in response to the similarity score corresponding to the comparison result greater than or equal to a score threshold or within a score threshold range, in other words, meeting the fourth preset condition, it is determined now that the target fingerprint region fails to pass the authentication. Accordingly, in response to the similarity score corresponding to the comparison result smaller than the score threshold or beyond the score threshold range, in other words, not meeting the fourth preset condition, it is determined now that the target fingerprint region passes the authentication. It will be appreciated that the fourth preset condition may be the same as or different from the second preset condition.

In the above FIG. 6A, in response to that the comparison result of the reference fingerprint image M (the secondary reference fingerprint region from the non-relevant fingerprint regions) and the overlapped second fingerprint feature set corresponds to a similarity score greater than or equal to the score threshold or within the score threshold range, it may be determined that the target fingerprint region (the fingerprint image E1) fails to pass the authentication. Accordingly, in response to that the comparison result of the reference fingerprint image M and the overlapped second fingerprint feature set corresponds to a similarity score smaller than the score threshold or beyond the score threshold range, it may be determined that the target fingerprint region (the fingerprint image E1) passes the authentication.

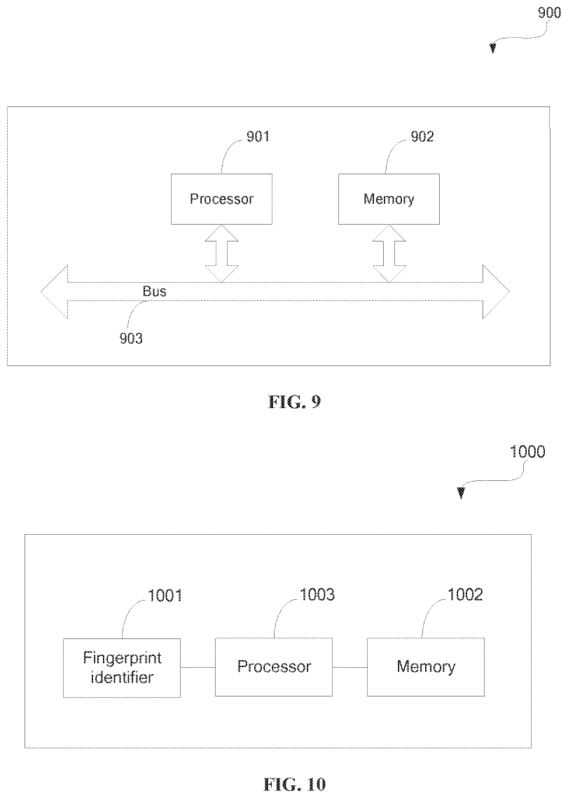

FIG. 9 is a block diagram of a device 900 for fingerprint authentication according to an embodiment of the present disclosure.

As shown in FIG. 9, the device 900 of the present disclosure may comprise a processor 901 and a memory 902. The processor 901 and the memory 902 communicate with each other via a bus 903. The memory 902 stores program instructions executable by the processor 901, and the program instructions, when executed by the processor 901, cause the device to perform steps of the method described above in conjunction with the figures.

The device 900 of the present disclosure may acquire a plurality of reference fingerprint regions in a swiping mode (by a finger performing arc-shaped sliding), which is faster than the mode of implementing fingerprint enrollment through multiple times of pressing in the prior art, thereby improving the efficiency in fingerprint enrollment. In view of this, in the solution of the present disclosure, the association between the reference fingerprint regions may be further used in authentication of the target fingerprint region, so that the target fingerprint region does not need to be compared with each reference fingerprint region, and therefore, the authentication process can be simplified while ensuring the authentication result, thereby speeding up the fingerprint authentication.

FIG. 10 is a block diagram of a mobile device 1000 for fingerprint authentication according to an embodiment of the present disclosure.

As shown in FIG. 10, the mobile device 1000 of the present disclosure may comprise a fingerprint identifier 1001, a memory 1002 and a processor 1003. The fingerprint identifier 1001 may be arranged on a side edge of the mobile device 1000 to receive an enrolled target fingerprint region. The memory 1002 may be configured to store a fingerprint database. The fingerprint database may store a plurality of reference fingerprint regions formed during fingerprint acquisition of a finger performing arc-shaped sliding on a fingerprint identifier, and each of the reference fingerprint regions has a corresponding fingerprint feature. The processor 1003 may be connected to the memory 1002, and configured to perform steps of the method described above in conjunction with the figures.

The mobile device 1000 of the present disclosure may acquire a plurality of reference fingerprint regions in a swiping mode (by a finger performing arc-shaped sliding), which is faster than the mode of implementing fingerprint enrollment through multiple times of pressing in the prior art, thereby improving the efficiency in fingerprint enrollment. In view of this, in the solution of the present disclosure, the association between the reference fingerprint regions may be further used in authentication of the target fingerprint region, so that the target fingerprint region does not need to be compared with each reference fingerprint region, and therefore, the authentication process can be simplified while ensuring accuracy of the authentication result, thereby speeding up the fingerprint authentication.

Those of ordinary skill in the art would appreciate that all or some of the steps for implementing the method embodiments described above can be performed by hardware related to program instructions. The foregoing program can be stored in a non-transitory computer-readable medium, and perform the steps of the method embodiments described above when executed.

Through the above description of the embodiments, it will be clearly understood by those skilled in the art that each embodiment can be achieved by means of software plus a necessary general hardware platform, and of course, by means of hardware. Based on such understanding, the technical solutions of the present invention essentially or, in other words, a part thereof contributing to the prior art, can be embodied in the form of a software product. The computer software product may be stored in a computer-readable storage medium, such as an ROM/RAM, a disk, or an optical disc, and comprises a number of instructions to make a computer device (which may be a PC, a server, a network device, or the like) to execute the methods described in the various embodiments, or in a certain portion thereof, of the present disclosure.

It should be understood that the terms “first,” “second,” “third,” “fourth,” and the like in the claims, description, and drawings of the present disclosure are used to distinguish between different objects, and are not used to describe a particular order. The terms “include” and “comprise”, as used in the description and claims of the present disclosure, specify the presence of stated features, integers, steps, operations, elements, and/or components, but do not preclude the presence or addition of one or more of other features, integers, steps, operations, elements, components, and/or combinations thereof.

It is also to be understood that the terminology used in the description of the present disclosure herein is for the purpose of describing particular embodiments only, and is not intended to limit the present disclosure. As used in the description and claims of the present disclosure, the singular forms “a”, “an” and “the” are intended to include the plural forms as well, unless the context clearly indicates otherwise. It should be further understood that the term “and/or” as used in the description and claims of the present disclosure refers to any and all possible combinations of one or more of the associated listed items and includes such combinations.

The above embodiments are only used to illustrate, but not to limit, the technical solutions of the embodiments of the present disclosure. Although the embodiments of the present disclosure have been described in detail with reference to the foregoing embodiments, those of ordinary skill in the art will understand that the technical solutions described in the foregoing embodiments may still be modified, or some or all of the technical features therein may be equivalently replaced. Such modifications or substitutions do not depart from the scope of the embodiments of the present disclosure by the essence of the corresponding technical solutions.

What is claimed is:

1. A method for fingerprint authentication, the method comprising:
obtaining a target fingerprint region to be authenticated, wherein the target fingerprint region includes at least one first fingerprint feature set;
judging, according to the at least one first fingerprint feature set and fingerprint feature sets included in a plurality of reference fingerprint regions of a fingerprint database, whether a primary reference fingerprint region associated with the target fingerprint region is included in the fingerprint database, wherein the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature set; and
determining, based on a judgment result, whether the target fingerprint region passes the authentication.

2. The method of claim 1, wherein the target fingerprint region further includes a second fingerprint feature set; and
the determining comprises:
selecting, in response to the judgment result that the fingerprint database includes a primary reference fingerprint region associated with the target fingerprint region, at least one corresponding reference fingerprint region from the fingerprint database as a secondary reference fingerprint region according to the primary reference fingerprint region; and
determining, based on a comparison of the secondary reference fingerprint region with the second fingerprint feature set, whether the target fingerprint region passes the authentication.

3. The method of claim 2, wherein the fingerprint database further includes relative positional relations between different ones of the plurality of reference fingerprint regions; and
the selecting comprises:
selecting, from the fingerprint database, at least one reference fingerprint region having a relative positional relation with the primary reference fingerprint region that meets a first preset condition, as the secondary reference fingerprint region.

4. The method of claim 3, wherein the relative positional relations between different reference fingerprint regions include distances and/or rotation angles between different reference fingerprint regions.

5. The method of claim 2, wherein the determining comprises:
judging whether a comparison result obtained by comparing the secondary reference fingerprint region with the second fingerprint feature set meets a second preset condition; and
determining, in response to the comparison result meeting the second preset condition, that the target fingerprint region passes the authentication.

6. The method of claim 5, wherein the comparison result is a similarity score; and
the determining comprises determining, in response to the similarity score corresponding to the comparison result greater than or equal to a score threshold or within a score threshold range, that the target fingerprint region passes the authentication.

7. The method of claim 1, wherein the determining comprises:
judging, in response to the judgment result that the fingerprint database includes a primary reference fingerprint region associated with the target fingerprint region, whether a reference fingerprint region associated with the target fingerprint region is included in a non-relevant fingerprint region of the fingerprint database according to the at least one first fingerprint feature set and the fingerprint feature sets included in the plurality of reference fingerprint regions of the fingerprint database,
wherein the non-relevant fingerprint region is a reference fingerprint region in the fingerprint database that has a relative positional relation with the primary reference fingerprint region meeting a third preset condition; and
determining, according to a judgment result, whether the target fingerprint region passes the authentication.

8. The method of claim 7, wherein the determining, according to the judgment result, whether the target fingerprint region passes the authentication comprises:
determining, in response to the judgment result that the non-relevant fingerprint region includes a reference fingerprint region associated with the target fingerprint region, that the target fingerprint region fails to pass the authentication.

9. The method of claim 1, wherein each of the reference fingerprint regions in the fingerprint database corresponds to an acquired reference fingerprint image, or each of the reference fingerprint regions includes one or more acquired fingerprint features.

10. The method of claim 9, wherein a plurality of reference fingerprint images or fingerprint features in the fingerprint database are acquired by:
acquiring a plurality of reference fingerprint images or fingerprint features while the finger performs the arc-shaped sliding from a first position to a second position on the fingerprint identifier,
wherein the first position and the second position are respectively located on two sides of a preset midline of the fingerprint identifier, and an angle between the first position and the second position is greater than or equal to a preset angle.

11. A device for fingerprint authentication, comprising:
a processor; and
a memory storing thereon program instructions executable by the processor, wherein the program instructions, when executed by the processor, cause the device to perform the operations of:
obtaining a target fingerprint region to be authenticated, wherein the target fingerprint region includes at least one first fingerprint feature set and at least one second fingerprint feature set;
judging, according to the at least one first fingerprint feature set and fingerprint feature sets included in a plurality of reference fingerprint regions of a fingerprint database, whether a primary reference fingerprint region associated with the target fingerprint region is included in the fingerprint database, wherein the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature set; and
determining, based on a judgment result, whether the target fingerprint region passes the authentication.

12. The device of claim 11, wherein the target fingerprint region further includes a second fingerprint feature set, and the program instructions, when executed by the processor, cause the device to perform the operations of:
selecting, in response to the judgment result that the fingerprint database includes a primary reference fingerprint region associated with the target fingerprint region, at least one corresponding reference fingerprint region from the fingerprint database as a secondary reference fingerprint region according to the primary reference fingerprint region; and
determining, based on a comparison of the secondary reference fingerprint region with the second fingerprint feature set, whether the target fingerprint region passes the authentication.

13. The device of claim 12, wherein the fingerprint database further includes relative positional relations between different ones of the plurality of reference fingerprint regions, and the program instructions, when executed by the processor, cause the device to perform the operation of:
selecting, from the fingerprint database, at least one reference fingerprint region having a relative positional relation with the primary reference fingerprint region that meets a first preset condition, as the secondary reference fingerprint region.

14. The device of claim 13, wherein the relative positional relations between different reference fingerprint regions include distances and/or rotation angles between different reference fingerprint regions.

15. The device of claim 12, wherein the program instructions, when executed by the processor, cause the device to perform the operations of:
judging whether a comparison result obtained by comparing the secondary reference fingerprint region with the second fingerprint feature set meets a second preset condition; and
determining, in response to the comparison result meeting the second preset condition, that the target fingerprint region passes the authentication.

16. The device of claim 15, wherein the comparison result is a similarity score, and the program instructions, when executed by the processor, cause the device to perform the operation of:
determining, in response to the similarity score corresponding to the comparison result greater than or equal to a score threshold or within a score threshold range, that the target fingerprint region passes the authentication.

17. The device of claim 11, wherein the program instructions, when executed by the processor, cause the device to perform the operations of:
judging, in response to the judgment result that the fingerprint database includes a primary reference fingerprint region associated with the target fingerprint region, whether a reference fingerprint region associated with the target fingerprint region is included in a non-relevant fingerprint region of the fingerprint database according to the at least one first fingerprint feature set and the fingerprint feature sets included in the plurality of reference fingerprint regions of the fingerprint database,
wherein the non-relevant fingerprint region is a reference fingerprint region in the fingerprint database that has a relative positional relation with the primary reference fingerprint region meeting a third preset condition; and
determining, according to a judgment result, whether the target fingerprint region passes the authentication.

18. The device of claim 17, wherein the program instructions, when executed by the processor, cause the device to perform the operation of:
determining, in response to the judgment result that the non-relevant fingerprint region includes a reference fingerprint region associated with the target fingerprint region, that the target fingerprint region fails to pass the authentication.

19. The device of claim 11, wherein each of the reference fingerprint regions in the fingerprint database corresponds to an acquired reference fingerprint image, or each of the reference fingerprint regions includes one or more acquired fingerprint features.

20. The device of claim 19, wherein the program instructions, when executed by the processor, cause the device to perform the operation of:
acquiring a plurality of reference fingerprint images or fingerprint features while the finger performs the arc-shaped sliding from a first position to a second position on the fingerprint identifier,
wherein the first position and the second position are respectively located on two sides of a preset midline of the fingerprint identifier, and an angle between the first position and the second position is greater than or equal to a preset angle.

21. A mobile device for fingerprint authentication, comprising:
a fingerprint identifier arranged on a side edge of the mobile device and configured to receive an enrolled target fingerprint region;
a memory configured to store a fingerprint database, wherein the fingerprint database stores a plurality of reference fingerprint regions formed during fingerprint acquisition of a finger performing arc-shaped sliding on a fingerprint identifier, and each of the reference fingerprint regions has a corresponding fingerprint feature; and
a processor connected to the memory and configured to perform the operations of:
obtaining a target fingerprint region to be authenticated, wherein the target fingerprint region includes at least one first fingerprint feature set;
judging, according to the at least one first fingerprint feature set and fingerprint feature sets included in a plurality of reference fingerprint regions of a fingerprint database, whether a primary reference fingerprint region associated with the target fingerprint region is included in the fingerprint database; and
determining, based on a judgment result, whether the target fingerprint region passes the authentication.

22. A non-transitory computer-readable medium having stored thereon program instructions for fingerprint authentication which, when executed by at least one processor, cause to implement the operations of:
obtaining a target fingerprint region to be authenticated, wherein the target fingerprint region includes at least one first fingerprint feature set;
judging, according to the at least one first fingerprint feature set and fingerprint feature sets included in a plurality of reference fingerprint regions of a fingerprint database, whether a primary reference fingerprint region associated with the target fingerprint region is included in the fingerprint database, wherein the plurality of reference fingerprint regions are formed during fingerprint acquisition of a finger performing arc-shaped sliding on a fingerprint identifier and stored in the fingerprint database, and each of the reference fingerprint regions has a corresponding fingerprint feature; and
determining, based on a judgment result, whether the target fingerprint region passes the authentication.
